(19) United States
(12) Patent Application Publication
(10) Pub. No.: US 2020/0262610 A1
(43) Pub. Date: Aug. 20, 2020

(54) STORAGE SYSTEM HAVING STACKABLE AND ENGAGEABLE VESSELS

(71) Applicants: Sesha Patel, Wilmington, NC (US); Shashin Patel, Wilmington, NC (US)

(72) Inventors: Sesha Patel, Wilmington, NC (US); Shashin Patel, Wilmington, NC (US)

(21) Appl. No.: 16/275,512

(22) Filed: Feb. 14, 2019

(51) Int. Cl. B65D 21/02; B65B 1/04; B67B 3/20; B65D 1/02

(52) U.S. Cl. CPC B65D 21/0231; B65D 1/0246; B67B 3/20; B65B 1/04

(57) ABSTRACT

A storage system includes a plurality of vessels each shaped to engage with an adjoining vessel in a top-to-bottom orientation. The volume of the vessels may vary. The lip of each vessel includes a plurality of radially positioned flanges, and the bottom of each vessel includes a plurality of radially positioned locking lugs that correspond and engage with the flanges upon rotation of one vessel relative to the other.

### BACKGROUND OF THE INVENTION

The present invention relates generally to storage systems, and more particularly, to a storage system having stackable and engageable vessels.

It is often desirable to transport, provide and store multiple vessels as a set that can be easily separated for use, and reconnected after use to keep the vessels together as a unit. An example of this is a set of beverages having multiple flavors such as cola, lemon-lime soda and root beer. Another example is a set of hair products that are intended to be used with one another such as shampoo, conditioner and leave-in conditioner. Yet other examples include alcohol and mixers for cocktails; baking materials such as flour and/or cake mixes; and infant formula mixes.

Transporting, providing and storing discrete materials including liquids, fluids, solids and semi-solids in a set usually requires multiple unattached vessels. For example, a beverage kit to make cranberry orange spritzer requires three separate containers: cranberry juice; orange juice; and seltzer. Unfortunately, however, having three separate containers increases the likelihood that one or more of the members will be misplaced. Also, it is more cumbersome to handle separate vessels versus one larger item.

As can be seen, there is a need for an improved storage system that includes multiple vessels configured to be joined together. It is desirable that the vessels can be easily and quickly engaged and disengaged as desired, and that the engagement structures don't interfere with normal usage of the vessels. It is also desirable that the storage system can accommodate as few or as many vessels as desired without modification.

### SUMMARY OF THE INVENTION

A storage system includes a plurality of vessels each sized and shaped to engage with an adjoining vessel in a top-to-bottom orientation. In a preferred embodiment the lip of each vessel includes a plurality of radially positioned flanges, and the bottom of each vessel includes a plurality of radially positioned locking lugs that correspond and engage with the flanges. The lip is sized and shaped to be inserted into the depression of an upwardly adjoining vessel, with the flanges and locking lugs engaged upon rotating one vessel relative to the other. In this manner a series of vessels can be engaged one to another in a stackable orientation.

### BRIEF DESCRIPTION OF THE DRAWINGS

FIG. 1 is a perspective view of a storage system;

FIG. 2 is a side view of a storage system;

FIG. 3 is a top plan view of a vessel without a cap;

FIG. 4 is a bottom view of a vessel;

FIG. 5 is a cross-sectional side view of a storage system in a stacking and interlocking orientation;

FIG. 6 depicts three capped vessels positioned separately;

FIG. 7 is a top perspective view of a vessel without a cap; and

FIG. 8 is a perspective view of the bottom of a vessel.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The following structure numbers shall apply to the following structures among the various FIGS.:
10—storage system;
20—vessel;
22—upper vessel;
23—middle vessel;
24—lower vessel;
26—upper portion;
27—upper tapering;
28—lower portion;
29—lower tapering;
30—cap;
35—interior cavity;
40—lip;
41—threads;
42—flange;
44—interflange region;
50—depression;
52—locking lug; and
54—interlug region.

Broadly, the present invention pertains to containers, and, more particularly, to a storage system includes a plurality of vessels each sized and shaped to engage with an adjoining vessel in a top-to-bottom orientation.

As used herein, “materials” shall refer to a broad range of substance having various forms including liquids, fluids, solids and semi-solids.

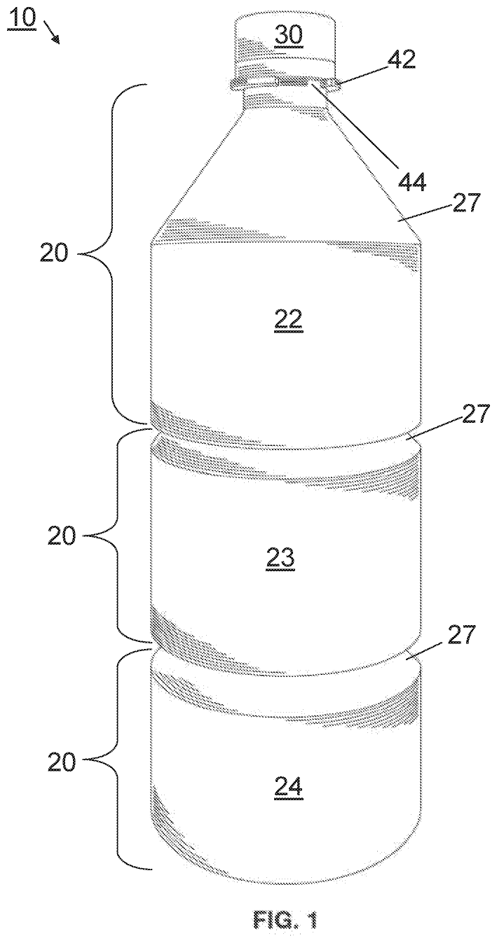

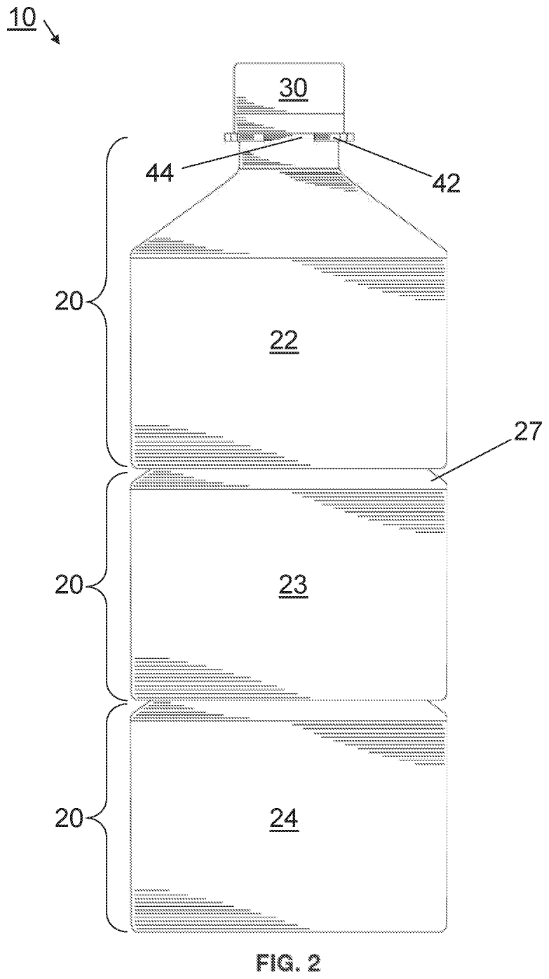

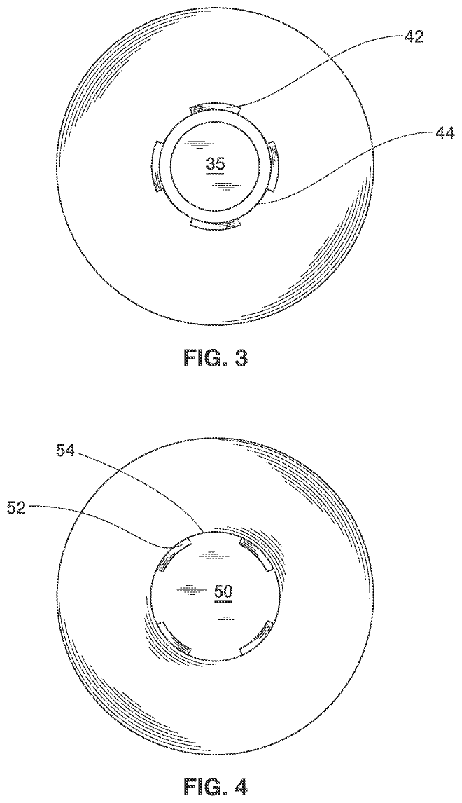

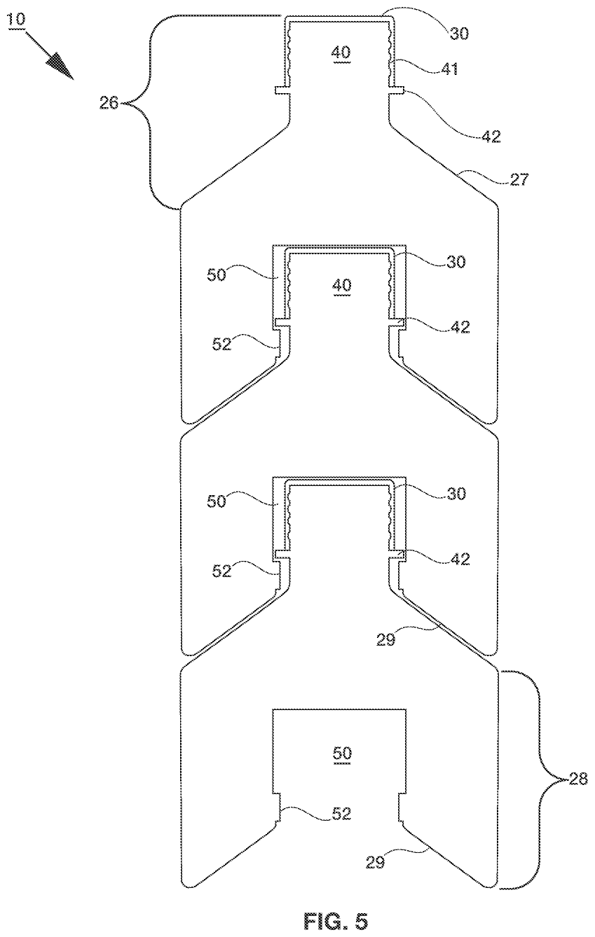

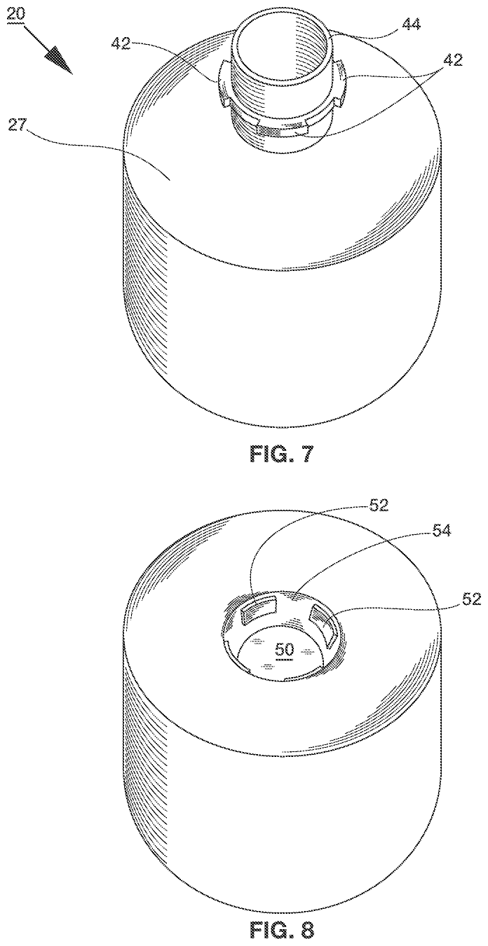

Referring to FIG. 1, storage system 10 includes a plurality of vessels 20. This figure depicts three vessels, upper vessel 22, middle vessel 23 and lower vessel 24, but it should be understood that vessels 20 could be added or subtracted to yield a storage system having as few as two vessels, and as many as desired, although approximately 20 is the preferred upper limit. Each vessel may be identically sized and shaped and includes upper portion 26 and lower portion 28 (see FIG. 5). Upper portion 26 includes a plurality of outwardly projecting flanges 42 positioned radially around the lip with a plurality of interflange regions 44 separating each flange 42 one from the other. Flanges 42 and interflange regions 44 are depicted most clearly in FIGS. 3 and 7. Lip 40 defines a plurality of threads 41 for engaging cap 30.

As best shown in FIG. 5, lower portion 28 of each vessel defines depression 50, which is sized and shaped to receive lip 40, cap 30 and flanges 42 of adjoining vessel. Said another way, the upper portion of the immediately lower vessel fits within the lower portion of the upper vessel.

Referring to FIGS. 4 and 8, depression 50 on bottom portion of vessel includes a plurality of inwardly projecting locking lugs 52 positioned radially. A plurality of interlug regions 54 separate each locking lug 52 one from the other. As shown best in FIG. 5, upper portion 26 defines upper tapering 27, which is substantially parallel with lower tapering 29 of lower portion 28.

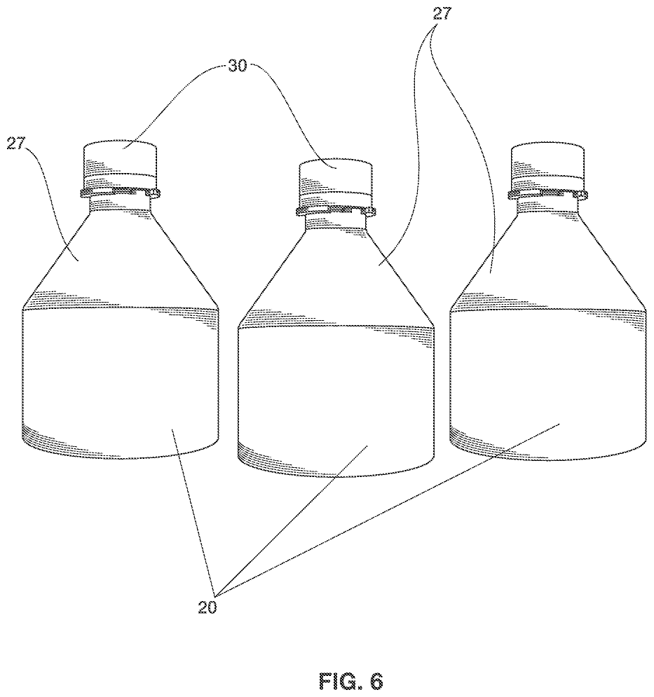

Referring to FIG. 6, vessels 20 are fully independent and can be used in the normal manner. Alternatively, two or more vessels can be engaged in a stacking orientation by engaging flange 42 to locking lug 52 via rotation. Vessels are disengaged by rotating one vessel relative to another, so flanges and locking lugs are unlocked and freely pass through interlug region 54 and interflange region 44 respectively.

Interior cavity 35 of vessel 20 preferably has a volume of approximately 15 ml to 2 L, with a volume of approximately 220 ml to 500 ml being preferred. The volume of each vessel need not be identical.

Conventional manufacturing methods such as injection molding, blow molding, stretch molding and extrusion are suitable for producing the vessels of the present invention. Preferably the vessels include conventional thread patterns and employ commercially available caps. Vessels are preferably constructed of polyethylene terephthalate (PET), but could also be constructed of high-density Polyethylene (HDPE), polystyrene (PS), other plastics, as well as glass, stainless steel, aluminum, and other metals.

It should be understood that the foregoing relates to exemplary embodiments of the invention and that modifications may be made without departing from the spirit and scope of the invention as set forth in the following claims. By way of example, material, sizes, volumes and mechanisms can differ. Terms such as “substantially” and the like shall mean within reasonable bounds when considering limitations such as machines, materials, manufacturing methods, and people. By way of example, a “substantially smooth” surface means there are no intentional bumps or irregularities. All ranges set forth herein include the endpoints as well as all increments there between, even if not specifically stated. By way of example 1 to 2 inches includes 1 inch, 1.000001 inches and so forth. Finally, unless otherwise stated or contrary to common sense, “approximate” and the like shall mean +/−10%.

What is claimed is:

1) A storage system including:
A. An upper vessel having a first upper portion and a first lower portion and defining a first interior cavity, said first lower portion defining a first depression having a first right cylindrical wall, said first right cylindrical wall including a first plurality of locking lugs projecting perpendicularly inward relative to said first right cylindrical wall;
B. A middle vessel having a second upper portion and a second lower portion and defining a second interior cavity, said second upper portion defining a second plurality of outwardly projecting flanges oriented substantially parallel relative to said first plurality of locking lugs, said second plurality of outwardly projecting flanges releasably locked and unlocked with said first inwardly projecting locking lugs by rotating said upper vessel relative to said middle vessel, and said second lower portion defining a second depression having a second plurality of inwardly projecting locking lugs, wherein said first upper portion and said second upper portion are substantially identically sized and shaped;
C. A first removable cap engaged with said upper vessel; and
D. A second removable cap engaged with said middle vessel.

2) The storage system of claim 1 further including a lower vessel having a third upper portion and a third lower portion, said third upper portion defining a third plurality of outwardly projecting flanges releasably engaged with said second plurality of inward projecting locking lugs, wherein said third upper portion is substantially identically sized and shaped as said second upper portion.

3) The storage system of claim 1 wherein each upper portion defines downwardly sloped upper tapering.

4) The storage system of claim 3 wherein each lower portion defines downwardly sloped lower tapering.

5) The storage system of claim 4 wherein said upper tapering is substantially parallel with said lower tapering.

6) The storage system of claim 5 wherein said first interior cavity is not in fluid communication with said second interior cavity.

7) A vessel for use in a stackable and engageable system including:
A) An upper portion having upper tapering and defining a lip having threads;
B) A plurality of outwardly projecting flanges spaced along the circumference of said lip;
C) A plurality of interflange regions separating each of said outwardly projecting flanges one from the other;
D) a lower portion having lower tapering and defining an upwardly oriented depression, said lower portion continuous with said upper portion;
E) A plurality of inwardly projecting locking lugs spaced along the circumference of said upwardly oriented depression;
F) A plurality of interlug regions separating each of said inwardly projecting locking lugs one from the other; and
G) A cap engaged with said threads.

8) The vessel of claim 7 wherein said upper tapering is substantially parallel to said lower tapering.

9) The vessel of claim 7 wherein said number of outwardly projecting flanges is equal to the number of inwardly projecting locking lugs.

10) The vessel of claim 9 wherein said number of outwardly projecting flanges is four.

11) The vessel of claim 7 wherein said upper portion and said lower portion define an interior cavity, said interior cavity having a volume of approximately 15 ml to approximately 2 L.

12) The vessel of claim 11 wherein said interior cavity has a volume of approximately 220 ml to approximately 500 ml.

13) A method of storing materials including the non-sequential steps of:
A. Filling a first vessel with a material;
B. Capping said first vessel;
C. Filling a second vessel with a material;
D. Capping said second vessel;
E. Positioning the upper portion of said second vessel within the depression of the lower portion of said first vessel; and
F. Engaging locking lugs of said first vessel with flanges of said second vessel.

14) The method of claim 13 wherein said step of engaging locking lugs with flanges includes the step of rotating said first vessel relative to said second vessel.

15) The method of claim 13 further including the step of filling a third vessel with a material;

16) The method of claim 15 further including the step of positioning the upper portion of said third vessel within the depression of the lower portion of said second vessel.

17) The method of claim 16 further including the step of engaging locking lugs of second vessel with flanges of third vessel.
